(19) United States
(12) Patent Application Publication
(10) Pub. No.: US 2009/0132403 A1
(43) Pub. Date: May 21, 2009

(54) LICENSING INTERFACE FOR USER GENERATED CONTENT

(75) Inventors: Tobin R. Titus, Issaquah, WA (US); Ernest A. Booth, Bellevue, WA (US); Erik Porter, Kirkland, WA (US); Elizabeth W. Goza, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/943,616

(22) Filed: Nov. 21, 2007

(51) Int. Cl. G06Q 10/00

(52) U.S. Cl. 705/35; 705/1

(57) ABSTRACT

Technologies are described herein for providing a licensing interface for user-generated content. A first interface and a second interface are provided. The first interface enables a user to upload a content item generated by the user. The second interface enables the user to associate a license with the uploaded content item. The license indicates one or more allowable uses of the uploaded content item and a compensation the user is to receive from the distribution of the uploaded content item.

### BACKGROUND

In recent years, massively multiplayer online (“MMO”) computer applications, such as massively multiplayer role-playing games (“MMORPGs”), have become extremely popular not only with serious gamers, but also with casual gamers and other Internet users. One example of a MMO computer application enables a participant to create and develop a fictional character in a virtual world. The fictional character is usually associated with an avatar or some other visual representation that enables other participants to recognize the particular fictional character. A given participant may develop, among other things, a storyline, a reputation, and attributes of her fictional character by interacting in the virtual world via the fictional character. Other examples of MMO computer applications may not involve the creation of a virtual world representation of the participant.

The virtual world typically includes an environment with a variety of virtual locations containing a variety of virtual objects. In some cases, the virtual locations and the virtual objects mimic realistic locations and objects, while in other cases, the virtual locations and virtual objects are fanciful creations. MMO computer applications generally permit the fictional character to travel across the virtual locations and interact with the virtual objects and other fictional characters.

One significant factor in the growth of MMO computer applications has been the ability for participants to create and distribute their own content to other participants within the MMO environment. Common types of user-generated content include multimedia files, such as text, picture, audio, and video files, as well as application plug-ins that may be utilized within a MMO computer application to provide additional functionality. An example of an application plug-in may be a graphical user interface (“GUI”) embedded within a social networking website that enables participants of the website to rate movies. In MMO environments, user-generated content may also include avatars and three-dimensional virtual objects, such as cars, buildings, and the like.

There currently exists no convenient way for a content creator to license her content to other participants within the MMO environment. In many cases, the content creator is limited to providing her content for free. More sophisticated content creators may be able to create and enforce licensing terms separate and apart from the MMO computer application. However, the typical recreational content creator does not have the ability and/or resources to define and enforce licensing terms.

It is with respect to these considerations and others that the disclosure made herein is presented.

### SUMMARY

Technologies are described herein for providing a licensing interface for user-generated content. In particular, through the utilization of the technologies and concepts presented herein, a user may utilize the licensing interface to upload content and to define and associate a license with the content. The license may be defined and uploaded via the licensing interface or generated via a licensing wizard provided by the licensing interface.

According to one aspect presented herein, a computer program provides an interface to license user-generated content. The interface may include a first interface and a second interface. The first interface enables a user to upload a content item generated by the user. The second interface enables the user to define and associate a license with the uploaded content item. The license may indicate one or more allowable uses of the uploaded content item as well as the compensation the user is to receive from the distribution and/or use of the uploaded content item.

It should be appreciated that although the features presented herein are described in the context of user-generated content within a MMO computer application, these features may be utilized with user-generated content configured for any suitable application including, but not limited to, other types of computer applications (e.g., a word processor) as well as online social communities. It should also be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network architecture diagram showing aspects of a network architecture capable of implementing a virtual world;

FIG. 2 is a screen display diagram showing an illustrative screenshot of a licensing interface, in accordance with one embodiment;

FIGS. 3 and 4 are screen display diagrams showing illustrative screenshots of a licensing wizard provided by the licensing interface, in accordance with one embodiment;

FIG. 5 is a screen display diagram showing an illustrative screenshot of an upload license interface provided by the licensing interface, in accordance with one embodiment;

FIG. 6 is a flow diagram showing an illustrative process for providing a licensing interface for user-generated content, in accordance with one embodiment; and

FIG. 7 is a computer architecture diagram showing aspects of an illustrative computer hardware architecture for a computing system capable of implementing the embodiments presented herein.

### DETAILED DESCRIPTION

The following detailed description is directed to technologies for providing a licensing interface for user-generated content. Through the utilization of the technologies and concepts presented herein, the licensing interface enables a content creator or other user to upload user-generated content and associate licenses to the user-generated content. In particular, each user-generated content item is associated with a license, according to one embodiment. The license may be stored locally or in some other location. The license may also be embedded within the user-generated content.

The content creator may upload a previously created license via an upload license interface provided by the licensing interface. Alternatively, the content creator may generate a license utilizing a licensing wizard also provided by the licensing interface. The licenses may be used to manage the distribution of the user-generated content to other users, specify the use of the user-generated content by other users, and define the compensation the content creator is to receive from the distribution of the user-generated content. Examples of user-generated content include, but are not limited to, multimedia files, avatars, three-dimensional virtual objects, and computer applications.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

Solely for illustrative purposes, the licensing interface is described herein in the context of a virtual world. Further, the licensing interface is described herein with reference to participant-generated content created by participants of the virtual world. It should be appreciated that the licensing interface is not so limited and may be utilized in a variety of other contexts and with any user-generated content. In particular, the licensing interface may be utilized with any user-generated content that is distributed through a content and/or service provider. Examples of user-generated content may include, but are not limited to, multimedia content, such as text, pictures, audio, video, and combinations thereof, as well as computer applications, such as application plug-ins that add new functionality to the content and/or service provider. Other examples of user-generated content include avatars and three-dimensional virtual objects. Examples of content and/or service providers may include, but are not limited to, social network websites (e.g., FACEBOOK from FACEBOOK INCORPORATED) and multimedia distribution services (e.g., ZUNE MARKETPLACE from MICROSOFT CORPORATION, ITUNES from APPLE INCORPORATED).

As used herein, the term virtual world refers to a computer-implemented environment, which may include simulated, lifelike environments as well as fanciful, non-existing environments. Exemplary virtual worlds may include any massively multiplayer online (“MMO”) computer application including, but not limited to, massively multiplayer online role-playing games (“MMORPGs”), virtual social communities, and virtual reality computer applications. In one embodiment, the MMO computer application simulates a real world environment. For example, the virtual world may be defined by a number of rules, such as the presence of gravity or the lack thereof. In other embodiments, the MMO computer application includes a fanciful environment that does not simulate a real world environment.

The virtual world is generally inhabited by avatars, which are virtual or symbolic representations of real world participants (hereinafter referred to as participants). As such, each avatar is typically associated with and controlled by a particular participant. Avatars may include two-dimensional and/or three-dimensional images. Through the virtual world, the avatars may interact with other avatars, as well as with virtual objects. Virtual objects may include virtual representations of real world objects, such as houses, cars, billboards, clothes, and soda cans, as well as fanciful creations, such as a teleportation machine or a flying car. According to exemplary embodiments, one or more virtual objects and one or more avatars in the virtual world are capable of providing an advertisement. The avatars and the virtual objects utilized in the virtual world may or may not be animated images.

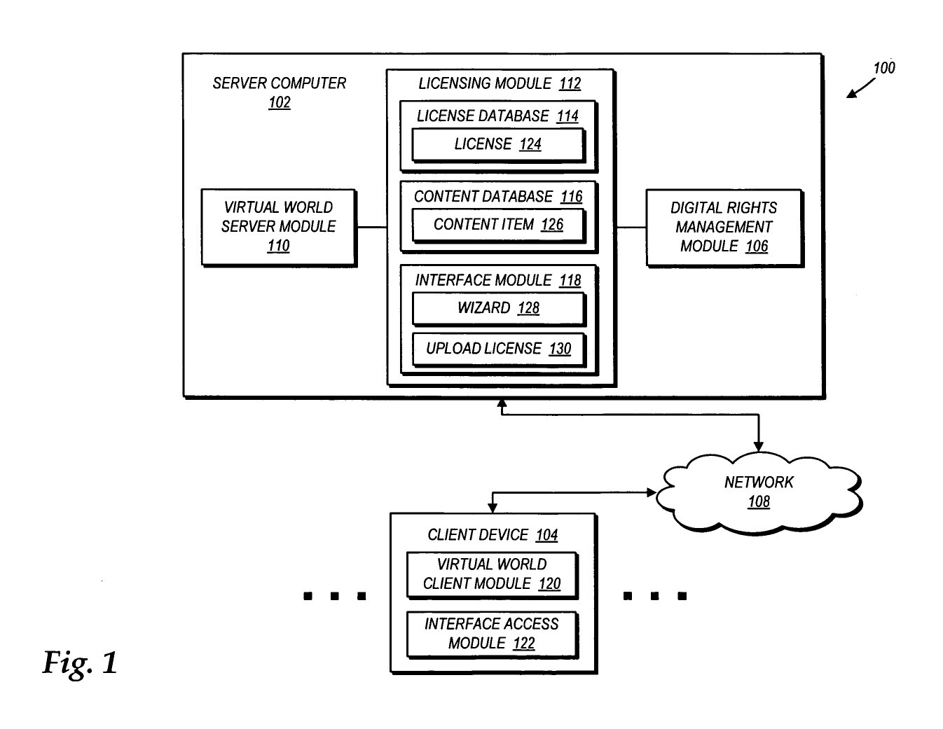

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for providing a licensing interface for participant-generated content will be described. In particular, FIG. 1 illustrates a simplified network architecture 100 for a virtual world. The network architecture 100 shown in FIG. 1 includes a server computer 102 and a client device 104, both of which are operatively coupled via a network 108. The network 108 may be any suitable network, such as a local area network (“LAN”) or the Internet. Although only one client device 104 is illustrated in FIG. 1, the network architecture 100 may include multiple client devices in any suitable network configuration.

The client device 104 may be any suitable processor-based device, such as a computer or a gaming device. Exemplary gaming devices include the XBOX and the XBOX 360 from MICROSOFT CORPORATION, the WII from NINTENDO COMPANY, LIMITED, and the PLAYSTATION 3 and the PSP from SONY CORPORATION. Although not so illustrated in FIG. 1, the client device 104 may be coupled to any suitable peripheral devices to enable the participant to experience and interact with the virtual world. Exemplary peripheral devices may include an input device, such as a keyboard, a mouse, a microphone, and a game controller, and an output device, such as a display and speakers. Some peripheral devices may even provide both input and output functionality. For example, a game controller may provide vibration feedback.

As shown in FIG. 1, the client device 104 includes a virtual world client module 120, which interacts with the virtual world server module 110 executing on the server computer 102. In particular, the virtual world client module 120 may receive and process data from virtual world server module 110 and output the data to output devices coupled to the client device 104. Further, the virtual world client module 120 may receive data from input devices coupled to the client device 104 and transmit the data to the virtual world server module 110. The client device 104 may also include an interface access module 122, as illustrated in FIG. 1. In one embodiment, the interface access module 122 is a part of the virtual world client module 120.

The virtual world client module 120 may include any suitable component for accessing the virtual world server module 110. In one example, the virtual world client module 120 may be a computer application configured to locally provide at least a portion of the virtual world for the client device 104. In this way, the amount of data retrieved from the server computer 102 by the client device 104 to generate the virtual world may be reduced. In another example, the virtual world client module 120 may be a web browser configured to retrieve the virtual world from the virtual world server module 110. Since many public computers, such as those found in Internet cafes, commonly have a web browser installed and prohibit the installation of new computer applications, providing participants a way to access the virtual world via the web browser may provide greater accessibility and convenience.

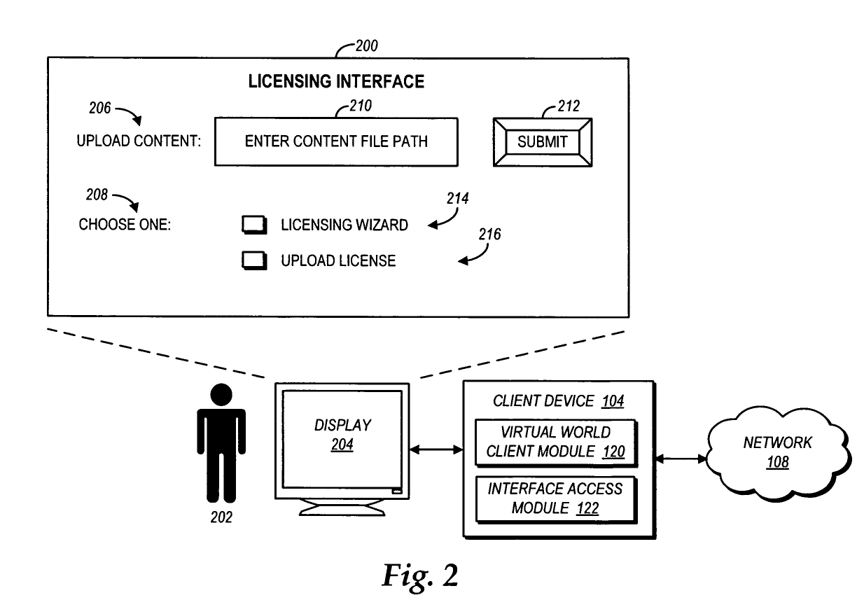

As shown in FIG. 1, the server computer 102 includes a virtual world server module 110, a licensing module 112, and a digital rights management (“DRM”) module 106. The virtual world server module 110 generally administers the virtual world and serves as a conduit between multiple client devices, including the client device 104. The licensing module 112 includes a license database 114, a content database 116, and an interface module 118. The content database 116 stores participant-generated content, such as a participant-generated content item 126. In one embodiment, the participant-generated content item 126 is uploaded from the client device 104 to the content database 116. The license database 114 stores one or more licenses, such as a license 124. In one embodiment, the license 124 is created via a licensing wizard 128 provided by the interface module 118. The licensing wizard 128 may provide a series of dialogs and predefined options that guide the content creator through a process to generate the license 124. In another embodiment, the license 124 is uploaded from the client device 104 via the upload license interface 130 also provided by the interface module 118. The operation of the interface module 118 is described in greater detail below with reference to FIGS. 2, 3, 4, 5, and 6.

In one embodiment, the enforcement of the licenses, such as the license 124, stored in the license database 114, with respect to distributing the participant-generated content item 126, is facilitated by way of the digital rights management (“DRM”) module 106. In particular, DRM may be utilized to manage, among other distribution and usage factors, the number of computing devices that can access the participant-generated content item 126, the number of times that the participant-generated content item 126 can be accessed, the length of time for which the participant-generated content item 126 can be accessed, the number of times that the participant-generated content item 126 can be transferred, the number of times that the participant-generated content item 126 can be copied, and the number of times that a computer-readable medium (e.g., CD-ROM, DVD-ROM) containing the participant-generated content item 126 can be created. DRM may also determine the amount of money to be charged for performing these distribution and usage factors. Each of these distribution and usage factors may be defined by the content creator via the interface module 118. It should be appreciated that other suitable methods for enforcing the licenses stored in the license database 114 may also be used.

In one embodiment, the DRM module 106 is a web server. An exemplary DRM process executed by the DRM module 106 may operate as follows for the participant-generated content item 126 (e.g., a multimedia file). First, the DRM module 106 encrypts the content item 126 with a key. The encrypted content item 126 includes a uniform resource locator (“URL”) pointing to the DRM module 106. The encrypted content item 126 may be provided to the virtual world, and a participant may obtain the encrypted content item 126 at the client device 104. When the participant attempts to access the encrypted content item 126, the participant is directed to the DRM module 106 where the participant can purchase or otherwise obtain the license 124 from the license database 114. If the participant agrees to the terms of the license 124, the license 124 may be copied to the client device 104. In this case, the license 124 may include the key with which to unlock the encrypted content item 126. The participant may then access the content item 126 subject to the limitations set forth by the license 124 stored in the client device 104. It should be appreciated that the above described DRM process is merely illustrative. Other suitable DRM processes may be utilized as contemplated by those skilled in the art.

A participant (e.g., the content creator) or other user (e.g., a broker representing the content creator) may access the interface module 118 via an interface access module 122. In one embodiment, the interface module 118 provides a website or other remote interface. In this embodiment, the interface access module 122 may be a web browser, which enables the participant to remotely access the website provided by the interface module 118. In other embodiments, the interface access module 122 may be any suitable computer application that provides the participant access to the interface module 118.

When a participant, such as the content creator, desires to access the virtual world, the participant may initiate the virtual world client module 120 to establish a session with the virtual world server module 110 via the network 108. During the session, the virtual world server module 110 may transmit data (e.g., environment layouts, avatar movements of other participants) associated with the virtual world to the virtual world client module 120. Similarly, the virtual world client module 120 may transmit data from associated input devices to the virtual world server module 110. The virtual world client module 120 in conjunction with the interface access module 122 may further interact with the interface module 118, as briefly mentioned above, to upload the participant-generated content item 126 from the client device 104 to the content database 116 for distribution in the virtual world and to create or upload the license 124 to the license database 114 to manage the distribution of the participant-generated content item 126 to other participants, manage the usage of the participant-generated content item 126 by other participants, and define the compensation the content creator is to receive from the distribution of the participant-generated content item 126.

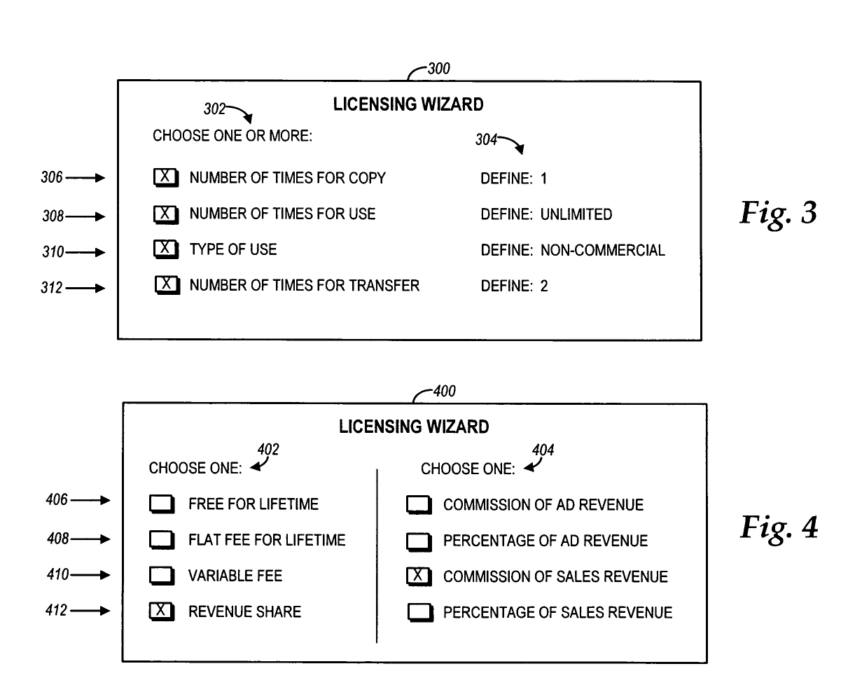

A number of exemplary screenshots of a licensing interface provided by the interface module 118 will now be presented with reference to FIGS. 2, 3, 4, and 5. It should be appreciated that the screenshots shown herein are merely illustrative. The licensing interface may be any suitable interface that enables a content creator or other user to upload the participant-generated content item 126 to be distributed within the virtual world and to create or upload the license 124 to associate with the participant-generated content item 126. In one embodiment, the license 124 is created using the licensing wizard 128, which is illustrated in FIGS. 3 and 4.

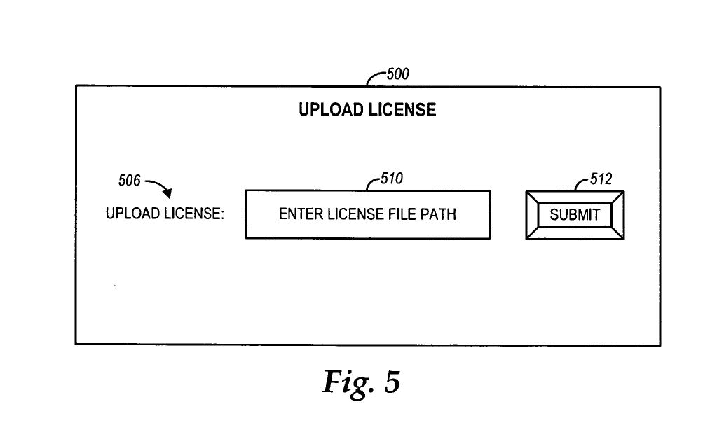

Turning now to FIG. 2, an illustrative screenshot 200 of the licensing interface provided by the interface module 118 and the interface access module 122 is shown, in accordance with one embodiment. A participant 202 may view the screenshot 200 on a display 204 operatively coupled to the client device 104. As shown in FIG. 2, the screenshot 200 includes an upload content section 206 and an interface selection 208. The upload content section 206 enables the participant 202 to upload one or more files corresponding to the participant-generated content item 126 from the client device 104 to the content database 116. In particular, the participant 202 may enter a file path and file name in a window 210 and click on a submit button 212 to initiate the upload. After the participant 202 uploads a file to the content database 116, the participant 202 can associate a license, such as the license 124, with the uploaded file by choosing the licensing wizard 128 at 214 or the upload license interface 130 at 216 in the interface selection 208. If the participant 202 chooses the licensing wizard 128, the interface module 118 may provide an interface as described in greater detail below with reference to FIGS. 3 and 4. On the other hand, if the participant 202 chooses the upload license interface 130, the interface module 118 may provide an interface as described in greater detail below with reference to FIG. 5.

Turning now to FIGS. 3 and 4, a first illustrative screenshot 300 and a second illustrative screenshot 400 of the licensing wizard 128 provided by the interface module 118 and the interface access module 122 are shown, in accordance with one embodiment. Referring to FIG. 3, the first screenshot 300 shows a portion of the licensing wizard 128 in which the participant 202 can define a range of allowable uses by other participants for the participant-generated content item 126 stored in the content database 116. In particular, the interface module 118 may provide a plurality of possible criteria with which to specify or limit the usage of the participant-generated content item 126. Upon selecting one or more applicable criteria from the plurality of possible criteria, the participant 202 may define the selected criteria based on personal preferences.

The first screenshot 300 includes a usage column 302 and a definition column 304 associated with the usage column 302. Corresponding to the usage column 302 and the definition column 304 is a first row 306, a second row 308, a third row 310, and a fourth row 312. The usage column 302 includes a number of times for copy criterion at the first row 306, a number of times for use criterion at the second row 308, a type of use criterion at the third row 310, and a number of times for transfer criterion at the fourth row 312. As used herein, the number of times for copy criterion specifies the number of times in which the participant-generated content item 126 can be copied. For example, the DRM module 106 may provide only a limited number of licenses for the participant-generated content item 126. According to the first row 306 of the definition column 304, the participant 202 has defined the number of times for copy criterion as one. As such, the participant-generated content item 126 can be copied only once. As used herein, the number of times for use criterion specifies the number of times in which the participant-generated content item 126 can be used. For example, the DRM module 106 may maintain a count for the number of times the participant-generated content item 126 is used. Once the count surpasses a threshold number, the DRM module 106 may terminate access to the participant-generated content item 126. According to the second row 308 of the definition column 304, the participant 202 has defined the number of times for use criterion as unlimited. As such, the participant-generated content item 126 has no limitation on the number of uses.

As used herein, the type of use criterion specifies whether the participant-generated content item 126 is for commercial and/or non-commercial use. The limitation of the type of use may be stated in an agreement provided to other participants prior to the purchase of the participant-generated content item 126. In this case, the other participants may purchase the participant-generated content item 126 only after agreeing the terms of the agreement. According to the third row 310 of the definition column 304, the participant 202 has defined the type of use as non-commercial. As such, the participant-generated content item 126 may not be used for commercial use. As used herein, the number of times for transfer criterion specifies the number of times the participant-generated content item 126 can be transferred from one computing device to another. For example, the DRM module 106 may maintain a count on the number of times the participant-generated content item 126 is transferred. Once the count surpasses a threshold number, the DRM module 106 may disable the transfer operation. According to the fourth row 312 of the definition column 304, the participant 202 has defined the number of times for transfer criterion as two. As such, the participant-generated content item 126 may be transferred only twice. Once the participant 202 has selected and defined the applicable criteria from the plurality of available criteria, the licensing wizard 128 proceeds to the second screenshot 400.

Referring to FIG. 4, the second screenshot 400 shows a portion of the licensing wizard 128 in which the participant 202 can define the compensation the participant 202 is to receive from the distribution of the participant-generated content item 126. In particular, the interface module 118 may provide a plurality of possible criteria with which to specify on what basis the participant 202 may be compensated. Upon selecting one or more applicable criteria from the plurality of possible criteria, the participant 202 may be compensated according to the selected criteria.

The screenshot 400 includes a compensation selection column 402 and a revenue selection column 404. Corresponding to the compensation selection column 402 and the revenue selection column 404 is a first row 406, a second row 408, a third row 410, and a fourth row 412. The compensation selection column 402 illustrates a number of different compensation criteria from which the participant 202 can choose. In particular, the compensation selection column 402 includes a free for lifetime criterion at the first row 406, a flat fee for lifetime criterion at the second row 408, a variable fee criterion at the third row 410, and a revenue share criterion at the fourth row 412. As used herein, the free for a lifetime criterion specifies that the participant-generated content item 126 is free for an unlimited duration. The flat fee for lifetime criterion specifies a single, unchanged rate to access the participant-generated content item 126. The variable fee criterion specifies a variable rate to access the participant-generated content item 126. For example, while the participant 202 may be compensated one amount under one circumstance, the participant 202 may be compensated by another amount under another circumstance. The variable rate may depend on any number of suitable factors specified by the interface module 118. In one example, the variable rate may be based, at least in part, on the popularity of one or more of the participant 202 generating the content item 126, the content item 126, and the other participants purchasing and/or accessing the participant-generated content item 126. The revenue share criterion specifies compensation in the form of revenue sharing when the participant-generated content item 126 is, for example, placed with advertising or utilized to sell a product or service. In the example shown in FIG. 4, the participant 202 has selected the revenue share criterion under the compensation selection column 402.

Upon receiving the selection of the revenue share criterion, the interface module 118 provides the revenue selection column 404. The revenue selection column 404 illustrates a number of revenue sharing criteria from which the participant 202 can choose. In particular, the revenue selection column 404 includes a commission of advertisement (“ad”) revenue option at the first row 406, a percentage of ad revenue option at the second row 408, a commission of sales revenue option at the third row 410, and a percentage of sales revenue option at the fourth row 412. As used herein, the commission of ad revenue option specifies that the participant 202 receives a flat amount for each advertisement view. The percentage of ad revenue option specifies that the participant 202 receives a percentage of the revenue generated for each advertisement view. The commission of sales revenue option specifies that the participant 202 receives a flat amount for each unit of the participant-generated content item 126 sold. The percentage of sales revenue option specifies that the participant 202 receives a percentage of the revenue generated for each unit of the participant-generated content item 126 sold. In the example shown in FIG. 4, the participant 202 has selected the revenue share option under the compensation selection column 402. Based on the input the participant 202 provides the licensing wizard, the interface module 118 generates a license, such as the license 124. The license 124 may be embodied in computer-readable media and stored in the license database 114. In particular, the license 124 may be in the form of a schema or a suitable programming language.

Turning now to FIG. 5, an illustrative screenshot 500 of the upload license interface 130 provided by the interface module 118 and the interface access module 122 is shown, in accordance with one embodiment. The screenshot 500 includes an upload license section 506. The upload license section 506 enables the participant 202 to upload one or more licenses, such as the license 124, that were generated by the participant 202 separate from the interface module 118. In particular, the participant 202 may enter a file path and file name in a window 510 and click on a submit button 512 to initiate the upload. The license 124 may be created in the form of a schema or a suitable programming language, as previously described. Although not shown in FIGS. 2, 3, 4 and 5, the licensing interface may also include a list of previously generated and uploaded licenses from which the participant 202 can choose. In this way, the participant 202 does not need to regenerate or re-upload the license 124.

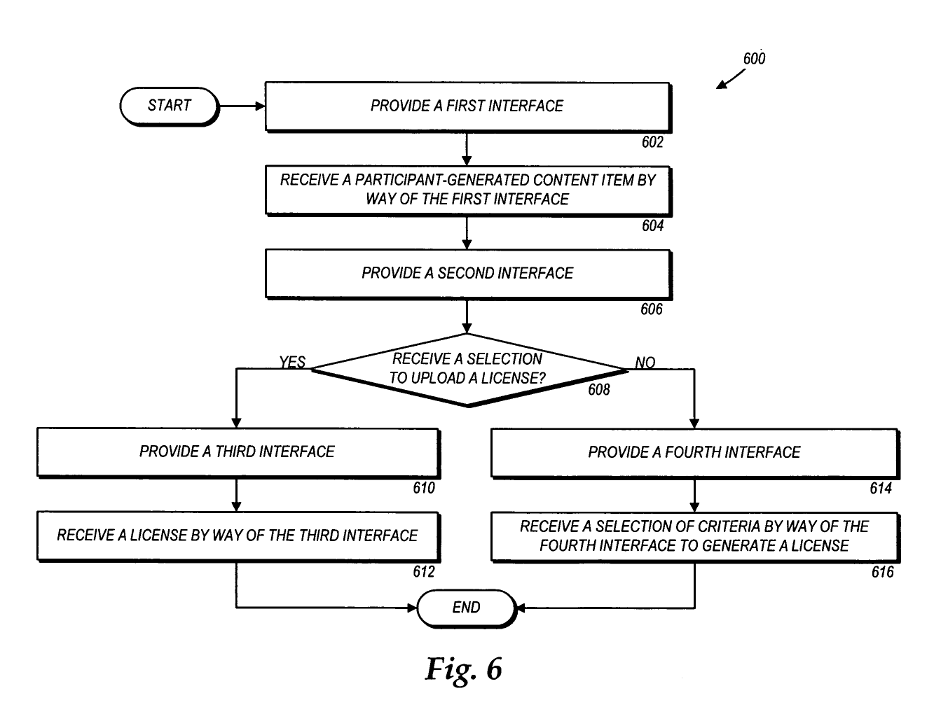

Referring now to FIG. 6, additional details will be provided regarding a license interface for participant-generated content. FIG. 6 is a flow diagram illustrating aspects of one method provided herein for providing a licensing interface enabling the participant 202 or other user to specify a range of allowable uses for the participant-generated content and a license fee structure that determines the compensation the participant 202 is to receive. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

Referring now to FIG. 6, a routine 600 begins at operation 602, where the interface module 118 provides a first interface enabling the participant 202 to upload the participant-generated content item 126. In one embodiment, the first interface comprises the upload content section 206. The routine 600 continues to operation 604 where the interface module 118 receives the participant-generated content item 126 by way of the first interface. The interface module 118 may store the participant-generated content item 126 in the content database 116. After the interface module 118 receives the participant-generated content item 126, the routine 600 continues to operation 606.

At operation 606, the interface module 118 provides a second interface enabling the participant 202 to choose between the licensing wizard 128 and the upload license interface 130. In another embodiment, the interface module 118 may provide another option that enables the participant 202 to select the license 124 from a plurality of previously generated and uploaded licenses. The routine 600 continues to operation 608 where the interface module 118 receives a selection of the licensing wizard 128 or the upload license interface 130. If the interface module 118 receives the selection of the upload license interface 130, the routine 600 continues to operation 610 where the interface module 118 provides the upload license interface 130 to the participant 202. At operation 612, the interface module 118 receives the uploaded license 124 from the participant 202 by way of the upload license interface 130. Alternatively, if the interface module 118 receives the selection of the licensing wizard 128, the routine 600 continues to operation 614 where the interface module 118 provides the licensing wizard 128 to the participant 202. As described above, the licensing wizard 128 enables the participant 202 to define a range of allowable uses for the participant-generated content item 126 and the license fee structure. In particular, the licensing wizard 128 may provide a plurality of available criteria identifying a range of allowable uses and a number of license fee structures. At operation 616, the interface module 118 receives a selection of criteria from the plurality of available criteria. The license 124 can be generated based on the selection of criteria.

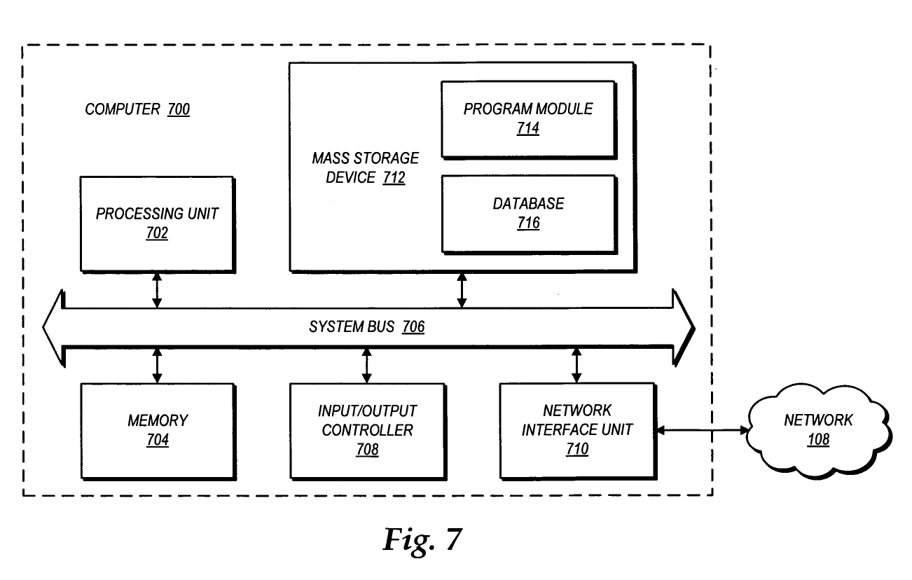

Referring now to FIG. 7, an exemplary computer architecture diagram showing aspects of a computer 700 is illustrated. Examples of the computer 700 may include the server computer 102 and the client device 104. The computer 700 includes a processing unit 702 (“CPU”), a system memory 704, and a system bus 706 that couples the memory 704 to the CPU 702. The computer 700 further includes a mass storage device 712 for storing one or more program modules 714 and one or more databases 716. Examples of the program modules 714 may include the interface module 118, the interface access module 122, and the DRM module 106. Examples of the databases 716 may include the license database 114 and the content database 116. The mass storage device 712 is connected to the CPU 702 through a mass storage controller (not shown) connected to the bus 706. The mass storage device 712 and its associated computer-readable media provide non-volatile storage for the computer 700. Although the description of computer-readable media contained herein refers to a mass storage device, such as a hard disk or CD-ROM drive, it should be appreciated by those skilled in the art that computer-readable media can be any available computer storage media that can be accessed by the computer 700.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 700.

According to various embodiments, the computer 700 may operate in a networked environment using logical connections to remote computers through a network such as the network 108. The computer 700 may connect to the network 108 through a network interface unit 710 connected to the bus 706. It should be appreciated that the network interface unit 710 may also be utilized to connect to other types of networks and remote computer systems. The computer 700 may also include an input/output controller 708 for receiving and processing input from a number of input devices (not shown), including a keyboard, a mouse, a microphone, and a game controller. Similarly, the input/output controller 708 may provide output to a display or other type of output device (not shown).

Based on the foregoing, it should be appreciated that technologies for providing a licensing interface for user-generated content are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing an interface to license user-generated content, the method comprising:
Providing, through a client computer, a first graphical user interface enabling a user to upload a content item generated by the user from the client computer to a server computer across a network; and
upon receiving the content item from the user, providing, through the client computer, a second graphical user interface enabling the user to associate a license with the uploaded content item on the server computer by selecting one or more allowable uses of the uploaded content item from a first list of available uses and by selecting a compensation the user is to receive from distribution of the uploaded content item from a second list of compensation options, the license indicating the selected allowable uses and the selected compensation.

2. (canceled)

3. The method of claim 1, wherein the first list comprises one or more of a number of computing devices that can access the uploaded content item, a number of times that the uploaded content item can be accessed, a length of time for which the uploaded content item can be accessed, a number of times that the uploaded content item can be transferred, a number of times that the uploaded content item can be copied, a number of times that a computer-readable medium containing the uploaded content item can be created, and a type of use for which the uploaded content item can be accessed.

4. The method of claim 1, wherein the second list comprises one or more of a no fee option, a flat fee option, a variable fee option, and a revenue sharing fee option.

5. The method of claim 4, wherein the no fee option comprises a fee structure that provides the user with no compensation if the uploaded content item is licensed to another user.

6. The method of claim 4, wherein the flat fee option comprises a fee structure that compensates the user with a set amount if the uploaded content item is licensed to another user.

7. The method of claim 4, wherein the variable fee option comprises a fee structure that compensates the user a different amount depending on a given circumstance associated with the uploaded content item.

8. The method of claim 4, wherein the revenue sharing fee option comprises a fee structure that compensates the user with a portion of advertising revenue generated from selling the uploaded content item to another user in accordance with the license.

9. The method of claim 4, wherein the revenue sharing fee option comprises a fee structure that compensates the user with a portion of sales revenue generated from selling the uploaded content item to another user in accordance with the license.

10. The method of claim 1, the method further comprising: providing, through the client computer, a third graphical user interface enabling the user to upload the license and to associate the license with the uploaded content item.

11. The method of claim 1, the method further comprising: providing, through the client computer, a third graphical user interface enabling the user to select the license from a list comprising a plurality of previously generated and uploaded licenses and to associate the license with the uploaded content item.

12. The method of claim 1, wherein the content item generated and uploaded by the user comprises a multimedia file.

13. The method of claim 1, wherein the content item generated and uploaded by the user comprises an application plug-in.

14. (canceled)

15. A computer system comprising:
a processor;
a memory operatively coupled to the processor; and
a program module (i) which executes in the processor from the memory and (ii) which, when executed by the processor, causes the computer system to provide an interface to license user-generated content by
providing, through a client computer, a content up load interface enabling a user to upload a content item generated by the user from the client computer to the computer system; and
providing, through the client computer, a licensing wizard enabling a user to associate a license with the uploaded content item, the licensing wizard further enabling the user to generate the license by defining a range of allowable uses by other users of the uploaded content item and a compensation the user is to receive from distribution of the uploaded content item.

16. The computer system of claim 15, wherein the licensing wizard further enables the user to generate the license by defining a range of allowable uses by other users of the uploaded content item and a compensation the user is to receive from the distribution of the uploaded content item comprises:
providing a first list of usage options from which the user can choose; and
providing as second list of compensation options from which the user can choose.

17. The computer system of claim 16, wherein the first list of usage options comprises one or more of a number of computing devices that can access the uploaded content item, a number of times that the uploaded content item can be accessed, a length of time for which the uploaded content item can be accessed, a number of times that the uploaded content item can be transferred, a number of times that the uploaded content item can be copied, a number of times that a computer-readable medium containing the uploaded content item can be created, and a type of use for which the uploaded content item can be accessed.

18. The computer system of claim 16, wherein the second list of compensation options comprises one or more of a no fee option, a flat fee option, a variable fee option, and a revenue sharing fee option.

19. (canceled)

20. A computer-readable medium having computer-executable instructions stored thereon which, when executed by a computer, cause the computer to:
providing, through a client computer, a first graphical user interface enabling a user to upload a content item from the client computer to a server computer, the server computer operative to administer a massively multiplayer online (MMO) application, the MMO application operative to enable the user to sell the uploaded content item to participants within the MMO application;
receiving the uploaded content item;
providing, through the client computer, a second graphical user interface enabling the user to associate a license to the uploaded content item by selecting one of a third graphical user interface, a fourth graphical user interface, and a fifth graphical user interface;
upon receiving a selection of the third graphical user interface, providing, through the client computer, the third graphical user interface enabling the user to define one or more usage options that specify allowable uses of the uploaded content item and to define a compensation that the user is to receive from distribution of the uploaded content item, the license being generated based on the defined usage options and the defined compensation;
upon receiving a selection of the fourth interface, providing, through the client computer, the fourth graphical user interface enabling the user to upload a file defining terms of the license; and
upon receiving a selection of the fifth interface, providing, through the client computer, the fifth graphical user interface enabling the user to select the license from a plurality of previously generated and uploaded licenses.

21. The method of claim 1, wherein the license is stored separately and apart from the uploaded content item.

22. The method of claim 1, wherein the content item is encrypted, and wherein the license comprises a key with which to unlock the encrypted content item.
